(19) United States
(12) Patent Application Publication
(10) Pub. No.: US 2024/0297566 A1
(43) Pub. Date: Sep. 5, 2024

(54) EARLY TRANSIENT LOAD DETECTION IN VOLTAGE CONVERTERS

(71) Applicant: TEXAS INSTRUMENTS INCORPORATED, Dallas, TX (US)

(72) Inventors: Amrutheshwara KV, Bangalore (IN); Preetam Tadeparthy, Bangalore (IN); Vikas Lakhanpal, Bangalore (IN); Vikram Gakhar, Bangalore (IN); Sreelakshmi S, Bangalore (IN)

(21) Appl. No.: 18/309,096

(22) Filed: Apr. 28, 2023

(30) Foreign Application Priority Data
Mar. 1, 2023 (IN) 202341013752

(51) Int. Cl. H02M 1/00; H02M 3/158

(52) U.S. Cl. CPC H02M 1/0025; H02M 1/0009; H02M 1/0012; H02M 3/158

(57) ABSTRACT

Provided herein are various enhancements for voltage regulators and associated control schemes that provide power to fast transient load circuitry. In one example, a power controller includes a transient detection circuit configured to monitor a change in timing among pulse signals associated with voltage conversion phases supplying current to a load circuit. The transient detection circuit is configured to identify a transient event condition corresponding to a change in current demand of the load circuit, and responsively output an indication of the transient event condition.

### RELATED APPLICATIONS

This application hereby claims the benefit of and priority to India Provisional Patent Application 202341013752, titled “Digital Detection of Transient Conditions to Improve Performance of Multiphase Buck Regulator,” filed Mar. 1, 2023, which is hereby incorporated by reference in its entirety.

### BACKGROUND

Voltage regulators or voltage converters can be employed in various topologies and configurations to provide desired voltages and currents to load circuitry, such as central processing units (CPUs) employed by computing systems. One example voltage regulator is the step-down converter, also referred to as a buck regulator, which has evolved into ‘multiphase’ versions to better support dynamic and high-current loads. These multiphase buck regulators are often used in datacenters to provide power to CPUs, network components, and peripheral devices. In such applications, multiphase buck regulators have been used to meet stringent requirements across various load slew transients, such as changes in load of many hundreds of amps per microsecond (A/μS)).

The transient behavior of certain loads, such as latest-generation CPUs and peripherals, has increased over the years, and even multiphase buck regulators struggle to detect these transients and respond with accuracy to prevent voltage overshoot or undershoot from being applied to such loads. In the event of fast load increases, an output voltage from a multiphase buck regulator can undershoot proportional to the increased load current as the regulator cannot deliver the required load current instantly. Similarly, in the event of fast load removal, the output voltage will overshoot as the regulator cannot instantly stop providing current to the load. Inductances used in the multiphase buck regulators and capacitances that reduce ripple on the voltage outputs can compound the transient response problems noted above.

When overshoot or undershoot conditions occur, they can lead to malfunction of the load circuitry, such as CPU shutdowns on voltage undershoots, or damage to circuitry on voltage overshoots. Current generations of multiphase buck regulators can use comparators to detect entry and exit of overshoot or undershoot conditions based on voltage levels presented to the load. However, these comparators cannot act quickly enough to prevent undesirable overshoot or undershoot conditions during very fast load transients, such as high slew rate load changes.

### SUMMARY

Provided herein are various enhancements for voltage regulators and associated control schemes that provide and regulate power for load circuitry. The examples herein provide circuitry and monitoring techniques to address high slew rates during load circuitry transient conditions, which can provide faster transient response to prevent or reduce undershoot or overshoot on voltages provided to the load circuitry. These enhanced features include monitoring timing properties of the signals used to activate switching elements within a voltage regulator. For example, the spacing among consecutive pulses in pulse width modulated (PWM) control signaling can be monitored, along with trends in the spacing, to more quickly determine when transients are occurring or ending. Various corrective actions can be taken based on these transient detections to prevent or reduce undershoot or overshoot on voltages provided to the load circuitry.

In one example implementation, a power controller includes a transient detection circuit configured to monitor a change in timing among pulse signals associated with voltage conversion phases supplying current to a load circuit. The transient detection circuit is configured to identify a transient event condition corresponding to a change in current demand of the load circuit, and responsively output an indication of the transient event condition.

In another example, a method includes monitoring, in a power control circuit, a change in timing among pulse signals that activate voltage conversion phases supplying current to a load circuit. Based on a property of the change, the method includes determining, in the power control circuit, a transient event condition corresponding to a change in current demand of the load circuit, and outputting an indication of the transient event condition.

In yet another example, an apparatus comprises one or more computer readable storage media and program instructions stored on the one or more computer readable storage media. The program instructions are executable by a processing system to direct the processing system to at least monitor spacing among pulse signals that activate voltage conversion phases supplying current to a load circuit. Based on a property of the spacing, the program instructions direct the processing system to at least determine a transient event condition corresponding to a change in current demand of the load circuit, and output an indication of the transient event condition.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example power system in an implementation.

FIG. 2 illustrates an example control scheme for a power system in an implementation.

FIG. 3 illustrates an example transient reduction configuration for a power system in an implementation.

FIG. 4 illustrates example operations for controlling a power system in an implementation.

FIG. 5 illustrates example operational parameters for a power system in an implementation.

FIG. 6A illustrates an example undershoot transient response for a power system in an implementation.

FIG. 6B illustrates an example overshoot transient response for a power system in an implementation.

FIG. 7 illustrates example undershoot transient detection for a power system in an implementation.

FIG. 8 illustrates example overshoot transient detection for a power system in an implementation.

FIG. 9 illustrates example trend-based transient detection for a power system in an implementation.

FIG. 10 illustrates an example implementation of a control system capable of implementing any of the control schemes discussed herein.

### DETAILED DESCRIPTION

A buck regulator takes an input voltage, such as 12 VDC and steps this voltage down to an output voltage, such as 1.0 VDC. Multiphase buck regulators include multiple power conversion phases coupled in parallel that can be quickly staged in/out as the load changes in magnitude. Multiphase buck regulators can also provide faster slew rates than traditional single phase buck regulators, as well as provide lower total ripple currents and employ smaller-sized passive components per-phase. Each phase has a transistor switch arrangement and inductor, and all phases are combined into a single output node that feeds a load circuit, such as a central processing unit (CPU) or other electrical device. A power controller generates activation signals for all phases, and provides a feedback control mechanism to determine when to alter the activation signals for each phase, such as to enable/disable phases or to increase/decrease the ‘gain’ of a particular phase to hit target levels for voltage or current. This control scheme can be referred to as load regulation. Conventional power controllers typically have comparators in load regulation feedback loops, and these feedback loops are used to regulate power supplied to the load over various load conditions.

The transient load variability and load magnitudes of certain devices, such as CPUs and graphics processing units (GPUs) have increased over time. Multiphase buck regulators often need to meet stringent overshoot and undershoot requirements across repetitive and high slew (e.g., ˜1080 A/μS) load transients. The conventional comparator-based feedback mechanisms of multiphase buck regulators struggle to detect transients quickly enough and cannot respond with sufficient accuracy to prevent voltage overshoot or undershoot from being applied to high slew loads. If the transients/slews become too large, then the resultant overshoots or undershoots can lead to unwanted effects on the target devices. In the discussion herein, several enhanced techniques and circuitry elements are provided that establish faster transient response to prevent or reduce overshoot/undershoot under high slew rate conditions.

The enhanced detection circuitry and techniques discussed herein are configured to monitor properties of activation signals driving the phases of a multiphase buck regulator. These activation signals typically comprise modulated or pulsed signals, such as pulse width modulated (PWM) signaling, which turns transistors of the various phases on or off according to the electrical current needs of a load. The monitored properties of the activation signals include separation or spacing between consecutive ones of the activation signals, and separation trends in such signals. Various thresholds can be established for entry or exit of transient conditions based on these monitored properties, and trends in changes among the monitored properties can also be employed, typically for determining preemptive or early exit from transient conditions. Early and preemptive detection of transient entry and exit conditions improve the transient response of multiphase buck regulators by enabling fine control over transient response techniques resulting in better voltage regulation provided to the load. Better droop values also can lead to use of lower output capacitance (Cout) which also contributes to lower part count and cost. The mentioned techniques also increase the ability of multiphase buck regulators to stay in tolerance bands over higher load magnitudes.

The enhanced detection schemes discussed herein can be referred to as forms of “digital” undershoot detection or “digital” overshoot detection, which include digitally monitoring properties of multiphase buck regulator pulse signals, such as pulse signal spacing, instead of analog comparator-based designs that monitor performance metrics such as output voltage directly. While the various techniques and circuitry discussed herein can be applied separately, often these will be included in a mixed-mode configuration having both a conventional comparator-based feedback mechanism along with the enhanced fast slew rate digital detection schemes. These configurations advantageously enable a power controller to detect undershoot and overshoot conditions efficiently across varying system requirements and slew rates.

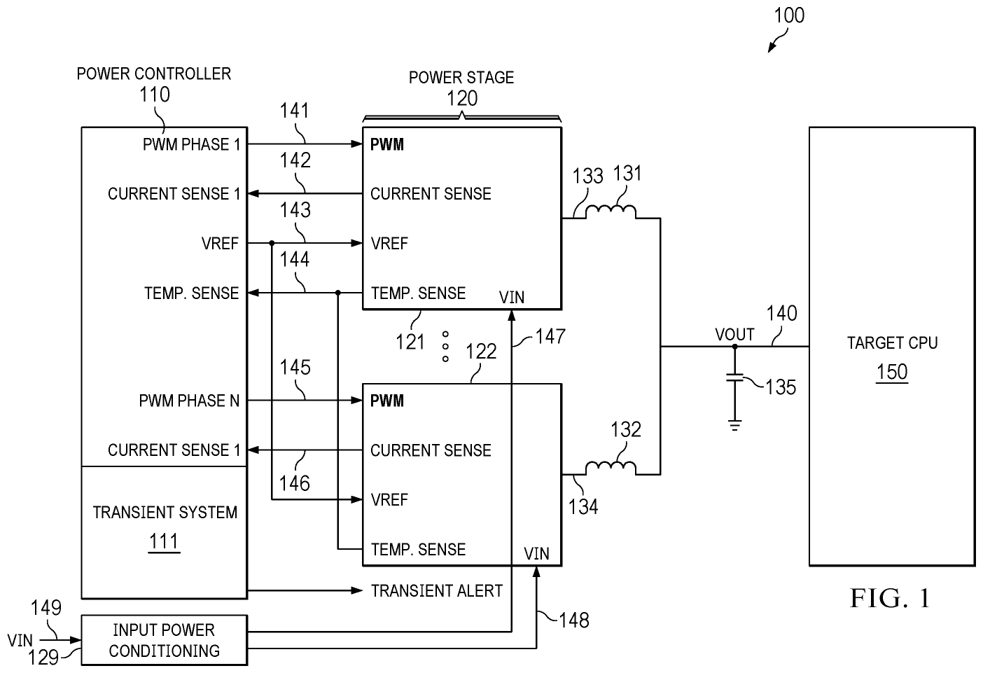

Turning to an example implementation, FIG. 1 is provided. FIG. 1 illustrates an example power system 100 that includes power controller 110, power stage 120, input power conditioning block 129, and target CPU 150. Power stage 120 includes a quantity 1-n of voltage conversion phases, shown as two exemplary phases 121-122 in FIG. 1. Power stage 120 provides output power to target CPU 150 at Vout node 140. Target CPU 150 is included as an example load circuit, and it should be understood that different load elements can be included in other examples.

Power controller 110 comprises any combination of integrated circuitry, which can include processors, processing circuitry, microprocessors, microcontrollers, application-specific integrated circuit (ASIC) elements, analog and digital circuitry, discrete logic elements, analog circuitry, memory or digital storage devices, digital signal processing (DSP) elements, graphics processing units, programmable logic elements, field-programmable gate arrays, and/or any other processing resources. In some examples, power controller 110 may include multiple components, such as any combination of the processing or circuitry resources listed above, as well as other discrete or integrated logic circuitry, and/or analog circuitry. Certain portions of the techniques of this disclosure, such as transient detection, load regulation, power regulation, power conversion elements, and monitoring circuitry, may be implemented with discrete components, passive components, and/or control links coupled between processing circuitry and the discrete components.

Power controller 110 provides control signaling to power stage 120 over links 141, 143, and 145. Links 141 and 145 comprise activation pulse signals, such as pulse width modulation (PWM) signaling, used to activate power phases 121-122. Link 143 provides a reference voltage (Vref) to power chases 121-122. Power controller 110 receives feedback or monitoring signaling over links 142, 144, and 146. Current sense links 142 and 146 provide an indication of a current provided by each power phase. Temperature sense link 144 provides an indication of the operating temperature of each power phase. The sense links may comprise analog or digital representations of the sensed property, and may share links using a timewise or rotating/handshaking configuration. Various other sensing or control links corresponding to power controller 110 are omitted in FIG. 1 for clarity, and can be coupled to various nodes of interest, such as Vout 140, Vin 149, and other various electrical nodes.

Power controller 110 includes transient system 111. Transient system 111 can be implemented with the above components mentioned for power controller 110, or instead may be implemented at least partially with separate circuitry from power controller 110. Transient system 111 includes circuitry to monitor properties of pulse signals provided to power stage 120, such as PWM signals provided over links 141 and 145. Transient system 111 can determine alerts for entry and exit of transient states or transient modes of operation. These alerts can be provided to various circuitry which mitigates voltage overshoot or undershoot of power stage 120. Portions of this mitigation circuitry can be included in power controller 110, or in discrete or separate circuitry (not shown in FIG. 1 for clarity). The alerts can comprise discrete analog or digital signaling, various digital messaging, or can be provided over a serial link, data bus, optical link, wireless link, or other various links. Transient system 111 also provides for programmable elements which can be used to alter various transient performance aspects, such as thresholds and trend levels.

Power stage 120 includes power phases 121-122 each comprising a power handling portion of a buck converter circuit formed from one or more power transistor elements. These transistor elements can be activated (i.e., turned on, off, or placed into high impedance (Z) states) using control links coupled to corresponding transistor gate terminals. Various transistor topologies can be employed, such as two-switch buck converters, which accept a PWM signal coupled to gate terminals. Control of these gate terminals is used to select among directing an input voltage (Vin) to a switch node (133-134), to couple the switch nodes 133-134 to ground, or to let switch nodes 133-134 float (high-Z). By controlling signaling over links 141-145, power controller 110 can selectively enable or disable each power phase, as well as control operation for each phase once enabled. The selective adding or removal of active power phases within power stage 120 can provide an increased or decreased capacity for current supplied to the load (e.g., CPU 150) over Vout node 140. Vin is provided at links 147-148 to power phases 121-122, after conditioning in element 129 which can provide filtering, electromagnetic interference (EMI) protection, overvoltage protection, and other various conditioning of input power received at link 149.

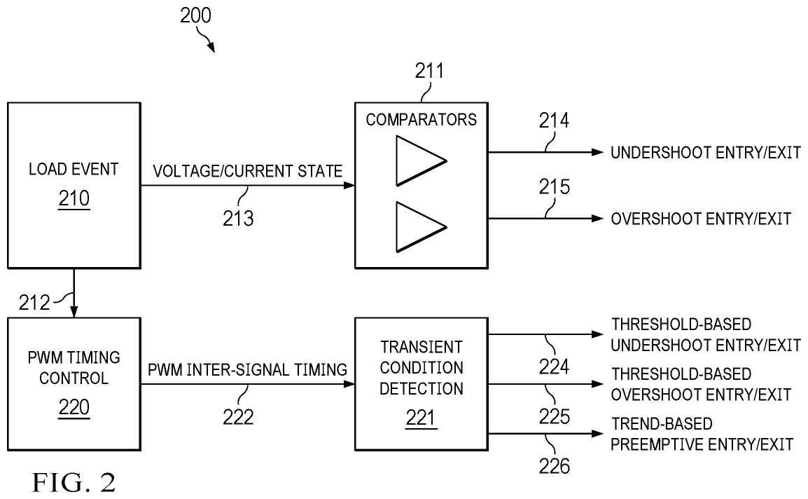

Turning now to operational descriptions of FIG. 1, FIG. 2 is provided. FIG. 2 includes an example control scheme 200 for power system 100, which includes several blocks indicating operational events or functional steps. Although reference is made below to elements of FIG. 1, it should be understood that the elements in FIG. 2 can be applied to other systems and elements discussed herein.

During operation, power controller 110 provides PWM signals to power phases 121-122 over links 141 and 145 based on detected/monitored load conditions of the load circuit coupled to node 140 (e.g., target CPU 150). These PWM signals can be produced in PWM timing control block 220. During steady-state operation, the PWM signals remain consistent at a constant pulse width and pulse spacing, and the quantity of phases enabled remains constant. As the load changes in power demand, load regulation is performed by PWM timing control block 220, monitoring load conditions indicated by link 212. This load regulation alters pulse width, spacing of pulses, or a quantity of phases active to suit the present load conditions and produce desired voltage/current levels for the load. However, transient events can lead to voltage overshoot or undershoot by the load regulation, where voltage at node 140 (Vout) may rise responsive to load reduction or fall responsive to load increases and normal load regulation fails to respond quickly enough.

Load event block 210 monitors change in load demand from a load circuit, such as CPU 150. Monitoring of voltage/current state (213) at node 140 (Vout) can provide an input to comparators 211. Comparators 211 are indicative of conventional comparator-based load regulation and transient detection, which monitors a present state of voltage/current provided at an output node of the power system (e.g. node 140). Based on predetermined or programmable thresholds, comparators 211 can produce an undershoot entry alert (214) or overshoot entry alert (215) which can be provided to power controller 110 for altering the properties of the PWM signals to power phases 121-122, such as pulse width, spacing of pulses, or a quantity of phases active. If an overshoot/undershoot condition is presently active (after prior entry), then based on the predetermined or programmable thresholds, comparators 211 can produce an undershoot exit alert (214) or overshoot exit alert (215) which can be provided to power controller 110 for further altering the properties of the PWM signals to power phases 121-122.

However, as noted above, the comparator-based load regulation architecture can fail to detect certain large transient events or fail to respond quickly enough to certain high slew rate transient events. Thus, transient condition detection block 221 is provided. Block 221 monitors properties of the PWM signals provided over link 222, such as pulse width, spacing of pulses, and a quantity of phases active. Based on these properties, block 221 can determine overshoot/undershoot entry/exit conditions and provide alerts for such conditions over links 224-226. Links 224-225 relate to threshold-based detection of changes to spacing of PWM pulses or PWM pulse widths. Link 226 relates to monitoring trends in PWM pulse properties for trend-based detection of anticipated changes to the PWM signals. These trends can be employed to preemptively enter/exit overshoot/undershoot states.

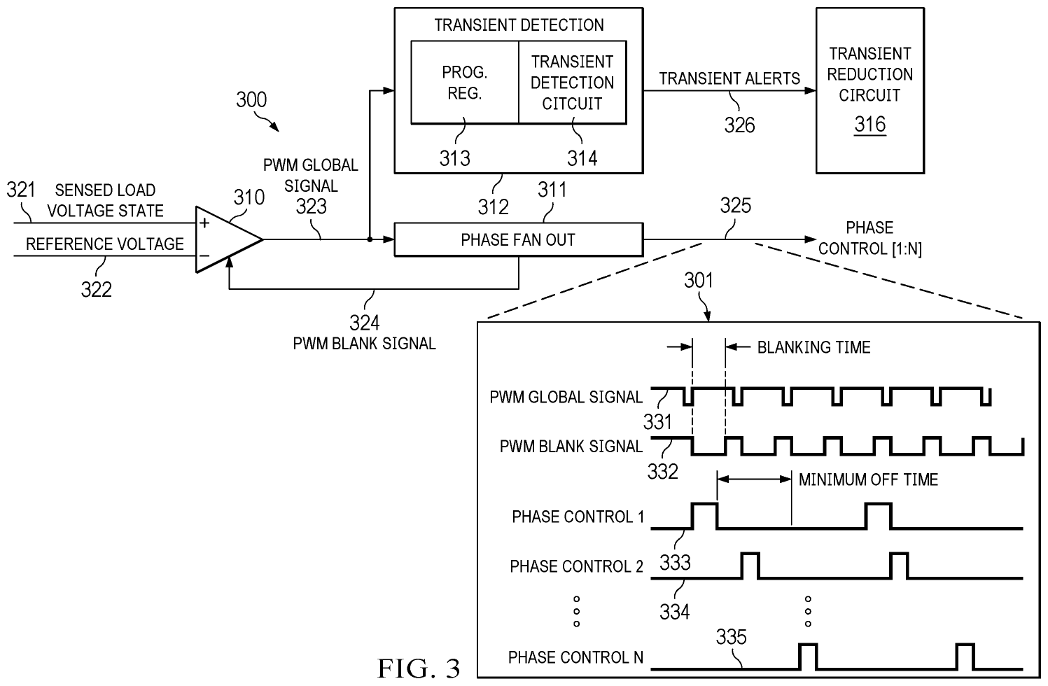

FIG. 3 illustrates an example transient reduction configuration 300 for a power system in an implementation. Configuration 300 includes circuitry which can be employed for creating a global PWM signal (PWM global signal 323) which is then fanned out into n-phases of signals by phase fan out block 311. This fan-out establishes individual PWM signals for each power phase of a multiphase buck converter (phase control 1-n (325)). Details of the multiphase buck converter are omitted from FIG. 3 for clarity, but elements from FIG. 1 can be employed in various examples. Sensed load voltage 321 from a Vout node (e.g., 140 in FIG. 1) is compared to reference voltage 322 by comparator 310. This comparator determines when activation is needed on PWM global signal 323, which is generated using PWM blank signal 324 indicating when the PWM signal should be inactive.

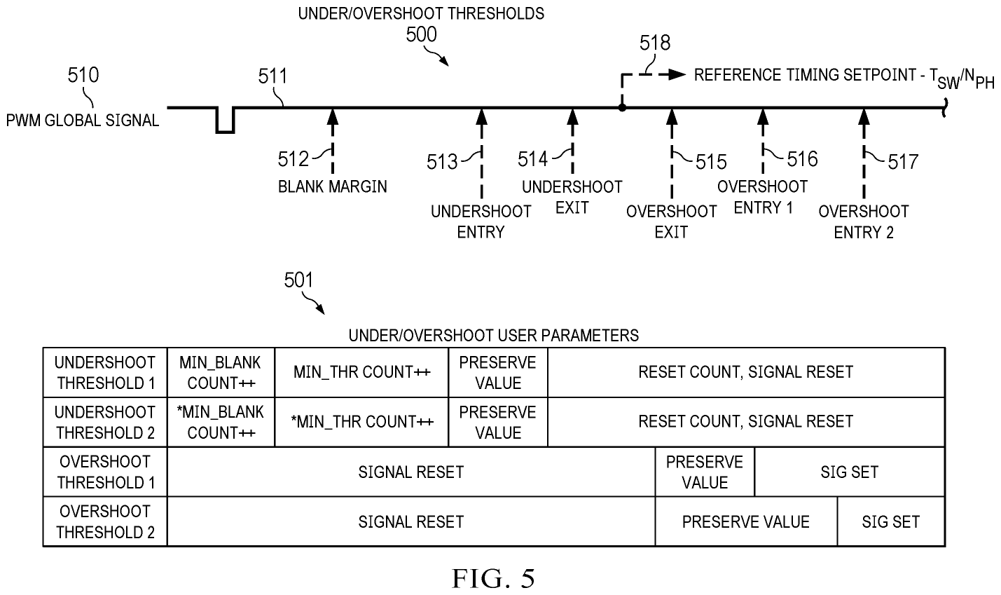

In addition to forming individual phase PWM signals, properties of PWM global signal 323 are monitored by transient detection block 312 to produce indications of transient event conditions as transient detection alerts over link 326. Transient detection circuit 314 comprises digital detection elements, such as circuit or software elements that monitor spacing among PWM pulses and trends in PWM pulse spacing changes (based on PWM global signal 323). When circuit elements are included, various timing detection circuitry can be employed to determine changes in spacing among pulses in PWM global signal 323. However, when software elements are employed, an analog-to-digital (A-to-D or A/D) conversion process can be performed to translate PWM global signal 323 into a digital representation. Transient detection circuit 314 can then determine pulse spacing properties and changes in such spacing over time (trends). Transient detection circuit 314 applies various overshoot/undershoot thresholds to spacing of pulses of PWM global signal 323 and various trend entry/exit parameters to changes in the spacing over time. Based on these thresholds or trends (discussed in FIG. 5), transient detection circuit 314 can produce transient alerts over link 326 indicating overshoot entry, overshoot exit, undershoot entry, or undershoot exit. These transient alerts might comprise binary signaling for each condition, or other representations, which may include a further digital-to-analog (D-to-A or D/A) conversion process. Transient reduction circuitry 316, response to transient detection alerts received over link 326, can enable circuitry to mitigate overshoot or undershoot on entry alerts, or to disable such circuitry on exit alerts.

In one scenario, based at least on a transient detection alert received over link 326 indicating an overshoot entry event, transient reduction circuitry 316 can reduce the voltage applied to the load circuit (Vout at node 140) by at least one of limiting the pulse signals that activate the voltage conversion phases and turning off transistors among the voltage conversion phases to reduce excess current supplied to the load circuit through body diodes of the transistors. In relation to FIG. 1, the PWM signaling on links 141 and 145 might be overridden by elements of transient reduction circuitry 316 to alter a state of power transistors of power phases 121-122 into either an off or high-Z configuration, allowing the current at Vout node 140 to drain to ground, thereby reducing a level of Vout. The state into which the power transistors are altered can depend on the present state of these transistors, such as if presently on or off. When the overshoot event is over, as indicated by an exit condition on link 326, then transient reduction circuitry 316 can disable any modification of links 141 and 145 and let the normal PWM signaling for the power phases provided by power controller 110 resume.

In another scenario, based at least on the indication of the transient event received over link 326 indicating an undershoot entry event, transient reduction circuitry 316 can increase the voltage applied to the load circuit (Vout at node 140) by at least one among turning on idle power phases and shortening the minimum allowed time between the pulse signals that activate the power phases. In relation to FIG. 1, the PWM signaling on links 141 and 145 can be altered, either by indicating to power controller 110 to turn on idle (off) phases among power stage 120, or to reduce the minimum allowed time between PWM signaling on links 141 and 145. These mitigations can produce a greater current for node 140 and the load by either activating more power conversion phases or to increase the turn-on time of presently ‘on’ phases. This has the effect of increasing a voltage level of Vout on node 140 by increasing a supply of current such that the voltage droop causing the undershoot is reduced or eliminated. When the undershoot event is over, as indicated by an exit condition on link 326, then transient reduction circuitry 316 can disable any modification of links 141 and 145 and let the normal PWM signaling for the power phases provided by power controller 110 resume.

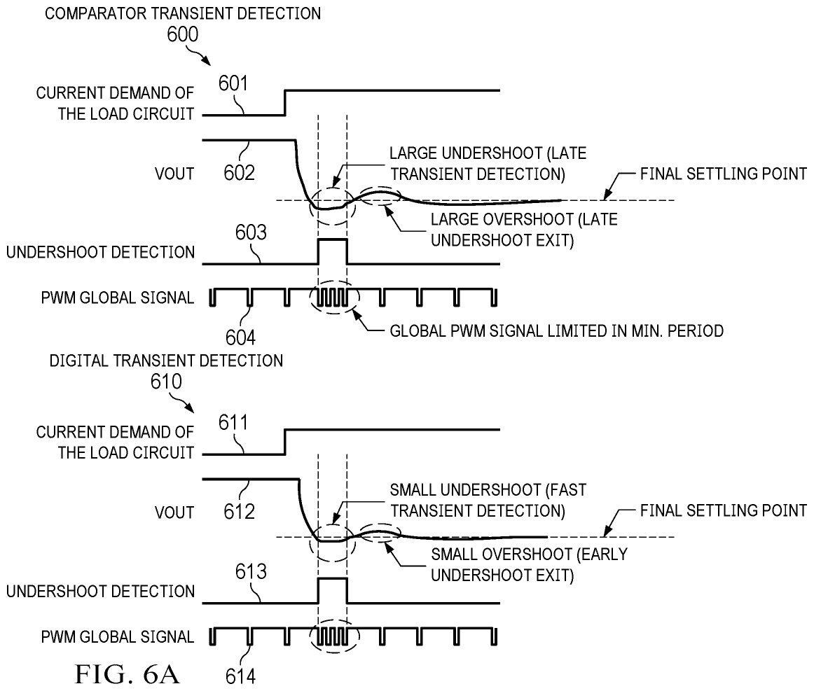

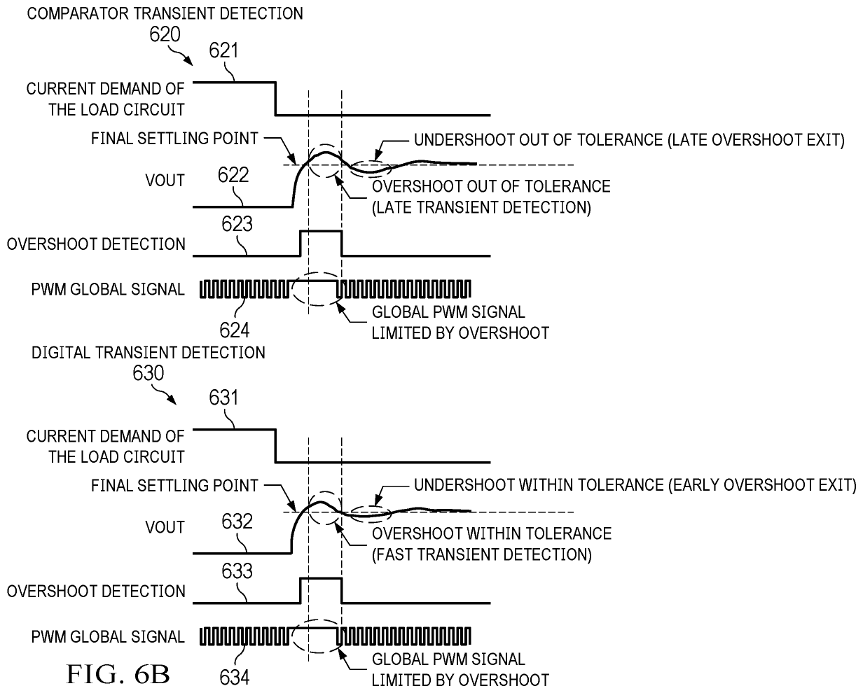

Graph 301 is provided to show a normal operation of PWM signaling in a steady-state case. The transient conditions noted above can then alter this signaling as seen in FIGS. 6-10. Trace 331 shows PWM global signal 323 in an example. PWM global signal 323 comprises a series of pulses which turn on various power phases after a fan-out process (311) establishes traces 333-335 for phase 1-n. Trace 332 shows PWM blank signal 324 which is used to gate off the output of comparator 310 to create PWM global signal 323. A minimum off time for individual phases is established and noted in graph 301, which can be altered during undershoot conditions.

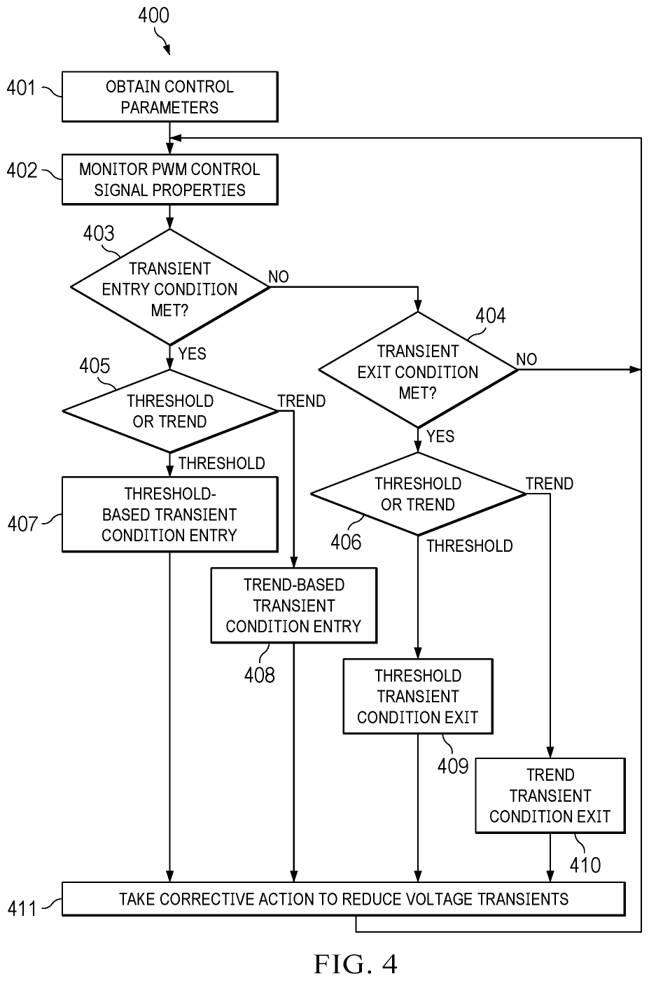

FIG. 4 is now presented, which includes example operations 400 comprising a detailed discussion of operational aspects of a power control system. Operations 400 are discussed in the context of FIG. 3 for clarity. However, as with the other operational scenarios and examples included herein, the operations of FIG. 4 can be applied across different circuitry and systems.

Operation 401 includes obtaining control parameters for operation of a power system. This can include reading settings or current configurations of programmable control registers used to indicate various thresholds for overshoot/undershoot entry/exit, or for trend-based overshoot/undershoot entry/exit. Transient detection block 312 includes programmable registers 313 which can comprise various memory or data storage elements for use by transient detection circuit 314.

FIG. 5 illustrates example programmable registers 501 in an implementation, which can be an example configuration of programmable registers 313. Programmable registers 501 can comprise various user-changeable parameters related to operation of a power controller or power system, as discussed herein. A user or operator can program or alter the settings in these registers using various interfaces, such as programmable interfaces, serial data interfaces, application programming interfaces (APIs), various command-line or graphical user interfaces, network interfaces, hard-wired interconnect or pin-programmable settings, programmable logic arrangements, software-defined parameters, or other various techniques. Default values can be included in each register to provide for a predetermined or default state of operation, which can include disabled or enabled states.

In a first set of registers, a first undershoot threshold (1) is defined, along with corresponding parameters for this first undershoot threshold, such as a minimum blanking count (incremental adjustment) corresponding to a undershoot threshold spacing between pulses, minimum threshold quantity of consecutive undershoot pulse events (incremental adjustment), a reserved/unused space, and a first threshold reset count/signal reset control register. A second set of registers, a second undershoot threshold (2) is defined, along with corresponding parameters for this second undershoot threshold, such as minimum blanking count (incremental adjustment) corresponding to a undershoot threshold spacing between pulses, minimum threshold quantity of consecutive undershoot pulse events (incremental adjustment), a reserved/unused space, and a second threshold reset count/signal reset control register. In a third set of registers, a first overshoot threshold (1) is defined, along with corresponding parameters for this first overshoot threshold, a first overshoot reset count/signal reset control register, a reserved/unused space, and a first overshoot signal set value. In a fourth set of registers, a second overshoot threshold (2) is defined, along with corresponding parameters for this second overshoot threshold, a second overshoot reset count/signal reset control register, a reserved/unused space, and a second overshoot signal set value.

An example PWM signal is shown in FIG. 5 as PWM global signal 510 having pulse 511, and shows how programmable registers 501 relate to operation of various thresholds and pulse properties of PWM global signal 510. The various thresholds can be established as relative to a reference timing setpoint (T_{SW/N_PH}). This corresponds to a PWM switching time (T_SW) divided by a quantity of power phases employed (N_PH). The undershoot/overshoot entry/exit thresholds are referenced relative to this reference timing setpoint. During operation of a power system, load regulation-based variations in the pulse timing of PWM global signal 510 can reach these thresholds, which then indicate or trigger transient alert conditions. The blank margin parameter refers to a programmable minimum width of the off time for PWM global signal 510.

Returning now to the operations of FIG. 4, in operation 402, transient detection circuit 314 monitors PWM control signal properties for changes in timing among pulse signals that activate voltage conversion phases supplying current to a load circuit. The changes in timing can correspond to changes in period, pulse width, pulse spacing, pulse frequency, or other pulse properties. In this example, the PWM control signal properties relate to a PWM global signal used to derive the individual power phase PWM signals. PWM global signals include PWM global signal 323 (e.g., trace 331) in FIG. 3 and PWM global signal 510 in FIG. 5.

As the spacing among consecutive pulses of PWM global signal 323 change due to load regulation, various threshold-based conditions (in seconds or μ s) or trend-based conditions (changes over multiple pulses) can be applied by transient detection circuit 314 which trigger one or more transient alerts. Transient entry conditions indicate a load current slew or load increase/drop which can cause overshoot or undershoot using conventional load regulation, as noted above. Transient exit conditions correspond to the transient load conditions subsiding to the point where normal load regulation is appropriate once again. It should be noted that a transient exit condition should follow a transient entry condition. Operation 403 includes transient detection circuit 314 monitoring for a transient entry condition, which when met, can correspond to either (operation 405) a threshold-based entry condition (operation 407) or a trend-based entry condition (operation 408). Conversely, if already in a transient condition/state, then operation 404 includes monitoring for a transient exit condition, which when met, can correspond to either (operation 406) a threshold-based exit condition (operation 409) or a trend-based entry condition (operation 410).

For threshold-based transient entry conditions (operation 407), a threshold can indicate when spacing or separation among consecutive pulses of PWM global signal 323 either exceeds an overshoot entry threshold or falls below an undershoot entry threshold. Based on the separation increasing to exceed an overshoot entry threshold, transient detection circuit 314 enters an overshoot condition for the voltage applied to the load circuit, and outputs an indication of entering the overshoot condition as an overshoot entry transient alert over link 326 to transient reduction circuit 316. Alternatively, based on the separation decreasing to fall below an undershoot entry threshold, transient detection circuit 314 enters an undershoot condition for the voltage applied to the load circuit, and outputs an indication of entering the undershoot condition as an undershoot entry transient alert over link 326 to transient reduction circuit 316. More than one entry threshold can be applied to both overshoot and undershoot. As seen in FIG. 5, two thresholds (1, 2) are indicated for overshoot and undershoot. A first entry threshold can produce a first alert, and a second entry threshold can produce a second alert. Remedies responsive to such alerts can produce different transient reduction actions, such as actions with increasing severity or to reduce the effect of a greater overshoot/undershoot.

For trend-based transient entry conditions (operation 408), a trend corresponds to either a series of increases in interval spacing or a series of decreases in interval spacing between the pulse signals of PWM global signal 323. Trends span more than one pulse instance, such as two or more pulses to determine if the spacing is changing between more than one consecutive pulse instance. One or more trend levels or trend triggers can be employed to signal entry among either overshoot or undershoot conditions. Based on a trend indicating an increasing series of spacings, transient detection circuit 314 can enter an overshoot condition for the voltage applied to the load circuit, and output an indication of entering the overshoot condition as an overshoot entry transient alert over link 326 to transient reduction circuit 316. Alternatively, based a trend indicating a decreasing series of spacings, transient detection circuit 314 can enter an undershoot condition for the voltage applied to the load circuit, and output an indication of entering the undershoot condition as an undershoot entry transient alert over link 326 to transient reduction circuit 316.

Responsive to the various transient entry alerts, and their types, transient reduction circuit 316 can take corrective action (operation 411) to reduce the overshoot or undershoot experienced in voltage levels applied to the load. The overshoot or undershoot in voltage can be caused by a change in current demand of the load circuit, such as during quick ramp-up in load circuit workloads or quick ramp-down of load circuit workloads. In examples where a CPU or GPU are configured as the load circuit, the workloads are typically software driven and based on execution states of processing circuitry incorporated into the CPU/GPU or other processing elements.

Based at least on the indication of the transient event condition indicating an overshoot event, transient reduction circuit 316 can reduce the voltage applied to the load circuit. In one example, transient reduction circuit 316 can act to limit the pulse signals being employed by a power controller to activate the voltage conversion phases. Specifically, transient reduction circuit 316 can include switch circuitry, such as transistors, that selectively couple the pulse signals for each phase to ground. This holds the pulse signals to a low or ‘0’ level, disabling one or more active phases to reduce the current being supplied to the load circuit. In combination or alternatively from limiting the pulse signals, responsive to the overshoot event, transient reduction circuit 316 can turn off transistors among the voltage conversion phases to reduce or remove excess current supplied to the load circuit through body diodes of the transistors. In this manner, transient reduction circuit 316 provides techniques to quickly turn off active power phases and shunt current away from the load circuit to reduce the effect of an overshoot event. Once the voltage is sensed to have returned to a level within a preferred operating range (indicating by spacing among the global PWM signal during load regulation operations), then an overshoot exit event can be determined, as discussed below. Multiple severities or stages of overshoot entry and exit can be established based on the anticipated or measured amount of overshoot, where one or more individual overshoot solutions discussed above can be applied based on corresponding overshoot thresholds.

Based at least on the indication of the transient event indicating an undershoot event, transient reduction circuit 316 can increase the voltage applied to the load circuit. In one example, transient reduction circuit 316 can activate or turn on idle phases among the voltage conversion phases. Specifically, transient reduction circuit 316 can include switch circuitry, such as transistors, that selectively couple the pulse signals for each phase to an active voltage state, such as a logical ‘1’ state. This holds the pulse signals to a high or ‘1’ level, enabling one or more active phases to increase the current being supplied to the load circuit. In combination or alternatively from activating the pulse signals, responsive to the undershoot event, transient reduction circuit 316 can shorten the minimum allowed time between the pulse signals that activate the voltage conversion phases. The minimum allowed time between the pulse signals can be referred to as the blanking period or minimum blanking period, and can be configured within a power controller that generates the pulse signals. By shortening the minimum allowed time between the pulse signals, phases can be active for longer and more phases can be active concurrently, leading to additional current supplied to the load, beyond that of non-transient operations. Once the voltage is sensed to have returned to a level within a preferred operating range (indicating by spacing among the global PWM signal during load regulation operations), then an undershoot exit event can be determined, as discussed below. Multiple severities or stages of undershoot entry and exit can be established based on the anticipated or measured amount of undershoot, where one or more individual undershoot solutions can be applied based on corresponding undershoot thresholds.

Once the voltage applied to the load is sensed to have returned to a level within a preferred operating range, then various exit conditions can be observed. For threshold-based transient exit conditions (operation 409), a threshold can indicate when spacing or separation among consecutive pulses of PWM global signal 323 either falls below an overshoot exit threshold or exceeds an undershoot exit threshold. Based on the separation falling below an overshoot exit threshold, transient detection circuit 314 exits an overshoot condition for the voltage applied to the load circuit, and outputs an indication of exiting the overshoot condition as an overshoot exit transient alert over link 326 to transient reduction circuit 316. Alternatively, based on the separation exceeding or increasing above an undershoot exit threshold, transient detection circuit 314 exits an undershoot condition for the voltage applied to the load circuit, and outputs an indication of exiting the undershoot condition as an undershoot exit transient alert over link 326 to transient reduction circuit 316. More than one exit threshold can be applied to both overshoot and undershoot. A first exit threshold can remove a first alert, and a second exit threshold can remove a second alert, as well as remove or disable corresponding corrective actions or remedies.

For trend-based transient exit conditions (operation 410) a trend corresponds to either a series of increases in interval spacing or a series of decreases in interval spacing between the pulse signals of PWM global signal 323. Trends span more than one pulse instance, such as two or more pulses to determine if the spacing is changing between more than one consecutive pulse instance. One or more trend levels or trend triggers can be employed to signal exit of either overshoot or undershoot conditions. Based on a decreasing trend, transient detection circuit 314 can determine that the voltage applied to the load is recovering from an overshoot condition, and output an indication of exiting the overshoot condition as an overshoot exit transient alert over link 326 to transient reduction circuit 316. Alternatively, based on an increasing trend, transient detection circuit 314 can determine that the voltage applied to the load is recovering from an undershoot condition, and output an indication of exiting the undershoot condition as an undershoot exit transient alert over link 326 to transient reduction circuit 316. More than one trend threshold can be established, such that a first trend threshold produces a gradual exit from a transient condition, while a second trend threshold produces an immediate exit from a transient condition. Trend-based overshoot or undershoot exits can be considered preemptive exits, as a transient event may still be occurring, but an exit trend indicates that it may soon be ending. In this manner, a smoother and more accurate return to normal load regulations can occur to establish the load voltage (by a power controller) into a preferred voltage range. Stepwise exits can also be reduced, along with reduced voltage noise and nonlinearities.

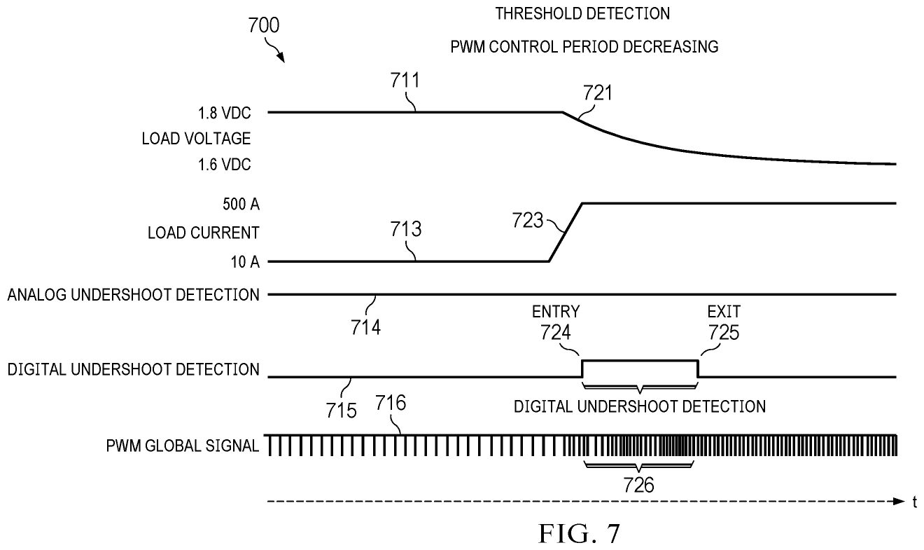

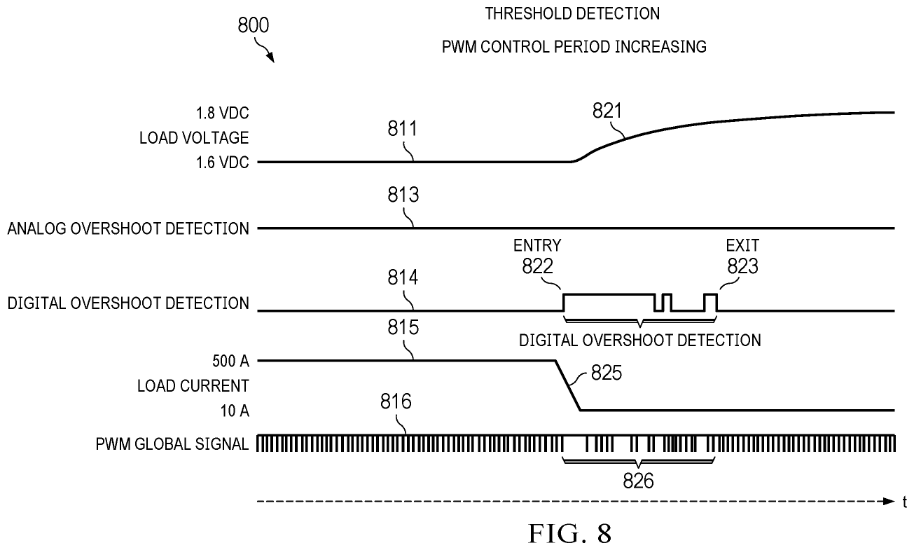

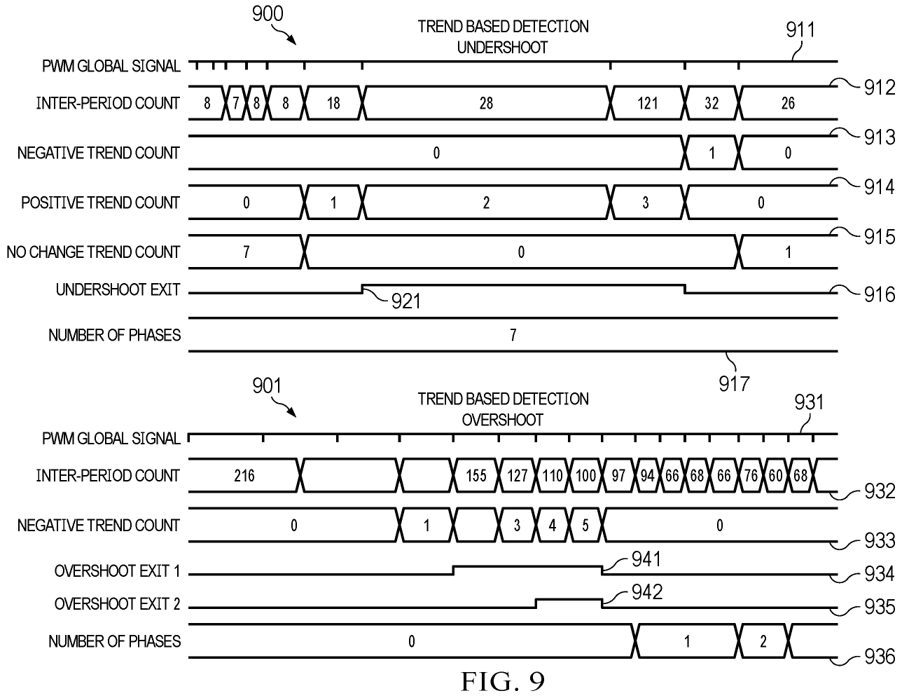

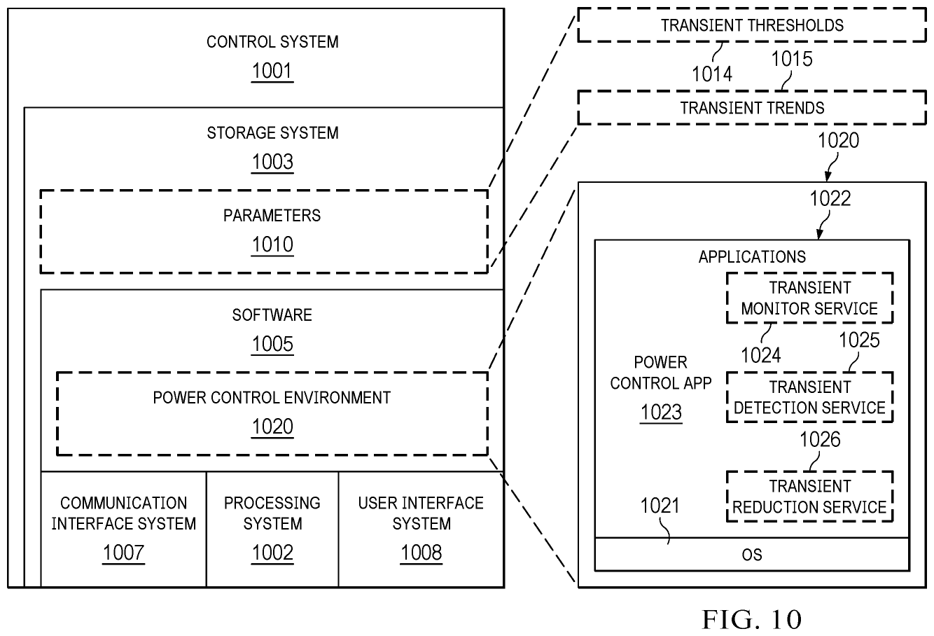

Turning now to several examples of operations of load regulation and enhanced transient response, FIGS. 6-9 are presented. The examples in FIGS. 6-9 can apply to any of systems and configurations discussed herein, such as power system 100 of FIG. 1, control scheme 200 of FIG. 2, configuration 300 of FIG. 3, or control system 1011 of FIG. 10, among systems and configurations. FIG. 6A includes example undershoot conditions, with graph 600 illustrating a conventional comparator-based solution, and graph 610 illustrating an enhanced transient response solution. FIG. 6B includes example overshoot conditions, with graph 620 illustrating a conventional comparator-based solution, and graph 630 illustrating an enhanced transient response solution. FIG. 7 includes a digital threshold-based undershoot transient entry condition. FIG. 8 includes a digital threshold-based overshoot transient entry condition. FIG. 9 illustrates trend-based transient condition exits for both undershoot (graph 900) and overshoot (graph 901).

Turning first to FIG. 6A, graph 600 shows several traces illustrating a conventional comparator-based solution for undershoot transient conditions. Specifically, trace 601 shows current demand for a load circuit, as provided by a power system. Trace 601 includes a stepwise increase in current demand, which exemplifies a high slew rate change in current. Trace 602 shows an output voltage from a power system, namely Vout, which experiences a droop from the rapidly increased current demand while supply current has not yet been increased from the power system. The final settling point (labeled) shows how a large undershoot on this voltage occurs from the transient condition (as well as some settling or oscillation which causes a brief Vout overshoot). Trace 603 shows that a comparator-based undershoot detection scheme does detect this undershoot condition. However, the relative timing of the undershoot detection compared to the initiation of the voltage droop creates a tardy detection leading to voltage undershoot. Accordingly, PWM global signal trace 604 shows how the pulse spacing changes in response to comparator-based load regulation. Specifically, the changes to establish decreased pulse spacing cannot establish a current increase quickly enough for the load to prevent or reduce undershoot. Moreover, a limit may be placed on how small of a spacing, or period, can be established on the PWM signal (trace 604), leading to a lower bound on how quickly current can be ramped up.

Graph 610 shows several traces illustrating an enhanced “digital” detection scheme, which uses various thresholds for PWM pulse spacing to initiate corrective actions. Specifically, trace 611 shows current demand for a load circuit, as provided by a power system. Trace 611 includes a stepwise increase in current demand, which exemplifies a high slew rate change in current. Trace 612 shows an output voltage from a power system, namely Vout, which experiences a droop from the rapidly increased current demand while supply current has not yet been increased from the power system. The final settling point (labeled) shows how a large undershoot is prevented in this example (as well as some settling or oscillation which causes a brief, but relatively smaller, Vout overshoot). Trace 613 shows a similar trace to 603 for a comparator-based undershoot detection scheme, which does detect this undershoot condition. However, in this example, a transient detection and/or correction circuit applies various corrections to quickly supply more current to the Vout node independently of the normal control loop and load regulation mechanism that generates PWM global signal 614 and undershoot detection signal 613. Thus, Vout experiences less droop, undershoot, and rebound (overshoot) in graph 610 than in graph 600.

Turning now to FIG. 6B, graph 620 shows several traces illustrating a conventional comparator-based solution for overshoot transient conditions. Specifically, trace 621 shows current demand for a load circuit, as provided by a power system. Trace 621 includes a stepwise decrease in current demand, which exemplifies a high slew rate change in current. Trace 622 shows an output voltage from a power system, namely Vout, which experiences a spike or rise from the rapidly decreased current demand while supply current has not yet been decreased from the power system. The final settling point (labeled) shows how a large overshoot on this voltage occurs from the transient condition (as well as some settling or oscillation which causes a brief Vout undershoot). Trace 623 shows that a comparator-based overshoot detection scheme does detect this overshoot condition. However, the relative timing of the overshoot detection compared to the initiation of the voltage rise creates a tardy detection leading to voltage overshoot. Accordingly, PWM global signal trace 624 shows how the pulse spacing changes in response to comparator-based load regulation. Specifically, the changes to the increased pulse spacing cannot establish a current decrease quickly enough for the load to prevent or reduce overshoot.

Graph 630 shows several traces illustrating an enhanced “digital” detection scheme, which uses various thresholds for PWM pulse spacing to initiate corrective actions. Specifically, trace 631 shows current demand for a load circuit, as provided by a power system. Trace 631 includes a stepwise decrease in current demand, which exemplifies a high slew rate change in current. Trace 632 shows an output voltage from a power system, namely Vout, which experiences a spike or rise from the rapidly decreased current demand while supply current has not yet been decreased from the power system. The final settling point (labeled) shows how a large overshoot is prevented in this example (as well as some settling or oscillation which causes a brief, but relatively smaller, Vout undershoot). Trace 633 shows a similar trace to 623 for a comparator-based overshoot detection scheme, which does detect this overshoot condition. However, in this example, a transient detection and/or correction circuit applies various corrections to quickly supply less current to the Vout node independently of the normal control loop and load regulation mechanism that generates PWM global signal 614 and overshoot detection signal 633. Thus, Vout experiences less rise, overshoot, and rebound (undershoot) in graph 630 than in graph 620.

FIG. 7 illustrates a threshold-based scheme for early detection of undershoot responsive to a large increase in current demand from a load circuit. Graph 700 shows several traces illustrating an enhanced “digital” detection scheme, which uses various thresholds for PWM pulse spacing to initiate corrective actions. Specifically, trace 713 shows current demand for a load circuit, as provided by a power system. Trace 713 includes a stepwise increase 723 in current demand from 10 amps (A) to 500 A, which exemplifies a high slew rate change in current. Trace 711 shows an output voltage from a power system, namely Vout, which experiences droop 721 from the rapidly increased current demand while supply current has not yet been increased from the power system. Trace 714 shows how an analog comparator-based undershoot detection scheme fails to detect this high slew rate transient condition, which would lead to a large undershoot experienced by the load circuit, possibly causing shutdown, malfunction, damage, or other unwanted behavior of the load circuit. Trace 715 shows a digital undershoot detection entry state (724) and exit state (725), which advantageously detects this high slew rate transient condition to reduce or prevent undershoot. As can be seen for transient event 726 (in PWM global signal 716), a decrease in spacing among PWM pulses occurs responsive to voltage droop 721 resultant from a current demand increase of the load. Based on one or more undershoot entry thresholds established, the decrease in spacing among PWM pulses can be detected by a transient detection circuit which provides an undershoot entry alert to a transient reduction circuit.

This transient reduction circuit can then apply one or more corrections to quickly supply more current to a Vout node (e.g., trace 711) independently of a normal control loop and load regulation mechanism that generates PWM global signal 716. For example, the transient reduction circuit can activate or turn on idle phases among voltage conversion phases of a power system. The transient reduction circuit can also shorten the minimum allowed time between the pulse signals that activate the voltage conversion phases. By shortening the minimum allowed time between the pulse signals, phases can be active for longer and more phases can be active concurrently, leading to additional current supplied to the load, beyond that of non-transient operations. Once the voltage applied to the load is sensed to have returned to a level within a preferred operating range based on PWM pulse spacing, then various undershoot exit conditions can be observed. An undershoot exit threshold can indicate when spacing or separation among consecutive pulses of PWM global signal 716 reaches an undershoot exit threshold. The transient detection circuit can then exit an undershoot condition and return the power system to normal load regulation operations.

FIG. 8 illustrates a threshold-based scheme for early detection of overshoot responsive to a large decrease in current demand from a load circuit. Graph 800 shows several traces illustrating an enhanced “digital” detection scheme, which uses various thresholds for PWM pulse spacing to initiate corrective actions. Specifically, trace 815 shows current demand for a load circuit, as provided by a power system. Trace 815 includes a stepwise decrease 825 in current demand from 500 A to 10 A, which exemplifies a high slew rate change in current. Trace 811 shows an output voltage from a power system, namely Vout, which experiences rise 821 from the rapidly decreasing current demand while supply current has not yet been decreased from the power system. Trace 813 shows how an analog comparator-based overshoot detection scheme fails to detect this high slew rate transient condition, which would lead to a large overshoot experienced by the load circuit, possibly causing shutdown, malfunction, damage, or other unwanted behavior of the load circuit. Trace 814 shows a digital undershoot detection entry state (822) and exit state (823), which advantageously detects this high slew rate transient condition to reduce or prevent overshoot. As can be seen for transient event 826 (in PWM global signal 816), an increase in spacing among PWM pulses occurs responsive to voltage rise 821 resulting from a current demand decrease of the load. Based on one or more overshoot entry thresholds established, the increase in spacing among PWM pulses can be detected by a transient detection circuit which provides an overshoot entry alert to a transient reduction circuit.

This transient reduction circuit can then apply one or more corrections to quickly supply less current to a Vout node (e.g., trace 811) independently of a normal control loop and load regulation mechanism that generates PWM global signal 816. For example, the transient reduction circuit can act to limit or turn off the pulse signals being employed by a power controller to activate the voltage conversion phases. The transient reduction circuit can also turn off transistors among the voltage conversion phases to reduce or remove excess current supplied to the load circuit through body diodes of the transistors. Once the voltage applied to the load is sensed to have returned to a level within a preferred operating range based on PWM pulse spacing, then various exit conditions can be observed. An overshoot exit threshold can indicate when spacing or separation among consecutive pulses of PWM global signal 816 reaches an overshoot exit threshold. The transient detection circuit can then exit an overshoot condition and return the power system to normal load regulation operations.

FIG. 9 illustrates trend-based transient condition exit techniques for both undershoot (graph 900) and overshoot (graph 901). Both graphs 900 and 901 assume a preexisting entry into an undershoot or overshoot condition, as appropriate. Thus, the transient event which led to undershoot or overshoot entry had already occurred, and is not included in graphs 900 and 901 for clarity.

In graph 900, a trend-based undershoot exit scenario, PWM global signal 911 shows a series of increasingly-spaced pulses, indicating current demand is lessening. Inter-period count 912 shows a count, in reference clock cycles, of the spacing between consecutive pulses of PWM global signal 911. As can be seen for inter-period count 912, an increasing trend occurs. A consecutive increase in period between at least two PWM global signal 911 pulses indicates that current demand is recovering from an undershoot condition. In some examples, a sudden increase in consecutive spacings, such as over a threshold increase trend, can produce an immediate exit from an undershoot condition. Negative trend count 913 indicates when the trend is decreasing, and positive trend count 914 indicates when the trend is increasing. No change trend count 915 can indicate when the trend remains the same or within a predetermined spacing range. As can be seen for undershoot exit 916, a low signal corresponds to remaining in the present state, whereas a high signal corresponds to an undershoot exit condition. Event 921 illustrates one example undershoot exit condition that corresponds to an increasing trend in PWM global signal 911. Finally, number of phases 917 corresponds to the presently active quantity of power phases, such as 7 in this example. The quantity of phases typically corresponds to the level of current demanded by a load circuit, but can be altered by transient correction circuitry.

In graph 901, a trend-based overshoot exit scenario, PWM global signal 931 shows a series of decreasingly-spaced pulses, indicating current demand is increasing. Inter-period count 932 shows a count, in reference clock cycles, of the spacing between consecutive pulses of PWM global signal 931. As can be seen for inter-period count 932, a decreasing trend occurs. A consecutive decrease in period between at least two PWM global signal 931 pulses indicates that current demand is recovering from an overshoot condition. In some examples, a sudden decrease in consecutive spacings, such as over a threshold decrease trend, can produce an immediate exit from an overshoot condition. Negative trend count 933 indicates when the trend is decreasing (a positive trend count and no change count are omitted in graph 901 for simplicity). As can be seen, two undershoot exit conditions are employed in this example. First undershoot exit (1) 934 has a low signal corresponding to remaining in a present state, and a high signal corresponding to a first overshoot exit condition. Second undershoot exit (2) 935 has a low signal corresponding to remaining in a present state, and a high signal corresponding to a second overshoot exit condition. Event 941 illustrates one example overshoot exit condition that corresponds to an first decreasing trend in PWM global signal 931. Event 942 illustrates one example overshoot exit condition that corresponds to a second decreasing trend in PWM global signal 931. Finally, number of phases 936 corresponds to the presently active quantity of power phases, such as an initial quantity of 0, followed by an increasing quantity in this example. The quantity of phases typically corresponds to the level of current demanded by a load circuit, but can be altered by transient correction circuitry. Thus, an overshoot condition previously turned off all phases to prevent further overshoot, and phases are slowly added as the overshoot condition is exited and normal load regulation resumes.

FIG. 10 illustrates an example implementation of a control system capable of implementing any of the control schemes discussed herein. FIG. 10 includes control system 1001. Control system 1001 is representative of any system or collection of systems in which the various operational techniques, architectures, scenarios, and processes disclosed herein may be implemented. For example, control system 1001 can be used to implement controller or control portions of power controller 110 or transient system 111 of FIG. 1, PWM timing control block 220 or transient condition detection block 221 of FIG. 2, transient detection block 312 or transient reduction circuit 316 of FIG. 3, or any of the control, transient detection, or transient correction of any of the Figures herein.

Control system 1001 may be implemented as a single apparatus, system, or device or may be implemented in a distributed manner as multiple apparatuses, systems, or devices. Control system 1001 includes, but is not limited to, processing system 1002, storage system 1003, software 1005, communication interface system 1007, and user interface system 1008. Processing system 1002 is operatively coupled with storage system 1003, communication interface system 1007, and user interface system 1008.

Processing system 1002 loads and executes software 1005 from storage system 1003. When executed by processing system 1002 to control a power system to affect designated load regulation, transient detection, overshoot/undershoot entry/exit, and overshoot/undershoot correction operations, software 1005 directs processing system 1002 to operate as described herein for at least the various processes, operational scenarios, and sequences discussed in the foregoing implementations. Control system 1001 may optionally include additional devices, features, or functionality not discussed for purposes of brevity.

Processing system 1002 may comprise processing circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, application specific processors, graphics processing units, programmable logic devices, field-programmable logic devices, application specific integrated circuit devices, digital signal processors, and discrete logic, as well as any other type of processing device and supporting circuitry, combinations, or variations thereof.

Storage system 1003 may comprise any tangible computer readable storage media readable by processing system 1002 and capable of storing software 1005. Storage system 1003 may include volatile and nonvolatile, removable and non-removable media implemented in any method or technology for storage of information, such as computer readable instructions, data structures, control programs, program modules, or other data. Examples of storage media include random access memory, read only memory, magnetic disks, optical disks, flash memory, virtual memory and non-virtual memory, magnetic storage media, magnetic storage devices, or any other suitable storage media. In no case is the computer readable storage media a propagated signal. In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 may be implemented in program instructions and among other functions may, when executed by processing system 1002, direct processing system 1002 to operate as described with respect to the various operational scenarios, sequences, and processes illustrated herein. For example, software 1005 may include program instructions comprising power control environment 1020 to implement operations 400 illustrated in FIG. 4 or other operations discussed herein. In particular, the program instructions may include various components or modules that cooperate or otherwise interact to carry out the various processes and operational scenarios described herein. The various components or modules may be implemented in compiled or interpreted instructions, or in some other variation or combination of instructions. Software 1005 may include additional processes, programs, or components, such as operating system software (e.g., 1021) or other application software (e.g., 1022), in addition to or that include power control environment 1020. Software 1005 may also comprise firmware or some other form of machine-readable processing instructions executable by processing system 1002.

Software 1005, when loaded into processing system 1002 and executed, may transform a suitable apparatus, system, or device (of which control system 1001 is representative) overall from a general-purpose computing system into a special-purpose computing system customized to control a power system to affect load regulation, transient detection, overshoot/undershoot entry/exit, and overshoot/undershoot correction operations, among other power monitoring and control operations. Indeed, encoding software 1005 on storage system 1003 may transform the physical structure of storage system 1003. For example, if the computer-readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to solid-state media, magnetic media, or optical media. Other transformations of physical media are possible without departing from the scope of the present description, with the foregoing examples provided only to facilitate the present discussion.

In one example implementation, software 1005 includes control process power control environment 1020 comprising operating system 1021 and applications 1022, at least some of which are representative of the operational techniques, algorithms, architectures, scenarios, and processes discussed with respect to the included Figures. Software 1005 can also employ parameters 1010 stored by storage system 1003. Parameters 1010 include transient threshold 1014 and transient trends 1015, which can be representative of any programmable registers, software-defined parameters, status indicators, user-controlled feature settings, or adjustment parameters discussed herein.

Applications 1022 include transient monitor service 1024, transient detection service 1025, and transient reduction service 1026. One or more software or firmware modules can perform functions of these services, and such modules can provide shared or distributed functionality. Transient monitor service 1024 is configured to monitor a change in timing among pulse signals associated with voltage conversion phases supplying current to a load circuit. Transient monitor service 1024 can read various programmable thresholds or trends from parameters 1010 for use during this monitoring.

From monitored changes in timing, transient detection service 1025 is configured to identify a transient event condition corresponding to a change in current demand of the load circuit and responsively output an indication of the transient event condition. Based on the spacing exceeding an overshoot entry threshold, indicate an overshoot entry condition for the voltage applied to the load circuit. Based on the spacing falling below an overshoot exit threshold or based on a decreasing trend in intervals between the pulse signals, transient detection service 1025 is configured to indicate an overshoot exit condition for the voltage applied to the load circuit. Based on the spacing falling below an undershoot entry threshold, transient detection service 1025 is configured to indicate an undershoot entry condition for the voltage applied to the load circuit. Based on the spacing increasing above an undershoot exit threshold or based on an increasing trend in the intervals, transient detection service 1025 is configured to indicate an undershoot exit condition for the voltage applied to the load circuit.

Transient reduction service 1026 can control various external circuitry which mitigates or corrects various undershoot or overshoot conditions and provides enhanced transient response for a power system. For example, based at least on the indication of the transient event condition indicating an overshoot event, transient reduction service 1026 is configured to instruct a transient reduction circuit to reduce the voltage applied to the load circuit by at least one of limiting the pulse signals that the activate voltage conversion phases and turning off transistors among the voltage conversion phases to reduce excess current supplied to the load circuit. Based at least on the indication of the transient event condition indicating an undershoot event, transient reduction service 1026 is configured to instruct the transient reduction circuit to increase the voltage applied to the load circuit by at least one of turning on idle phases among the voltage conversion phases and shortening the minimum allowed time between the pulse signals that activate the voltage conversion phases.

Communication interface system 1007 may include communication connections and devices that allow for communication with various circuit elements, such as discrete circuit elements, transistors, interface logic, A/D or D/A conversion units, or electrical components over communication links or communication networks (not shown). Examples of connections and devices that allow for communication may include logic interfaces, off-chip communication elements, signal drivers, signal receivers, transceivers, network interface controllers, and other communication circuitry. The connections and devices may communicate over communication media to exchange communications with other computing systems or networks of systems, such as metal, glass, air, or any other suitable communication media. Communication between control system 1001 and other elements or systems (not shown) via communication interface system 1007 may occur over data links, control links, communication links, or communication networks and in accordance with various communication protocols, combinations of protocols, or variations thereof. For example, control system 1001 might transfer control signaling over digital communication links comprising Ethernet interfaces, serial interfaces, serial peripheral interface (SPI) links, inter-integrated circuit (I2C) interfaces, universal serial bus (USB) interfaces, UART interfaces, discrete signaling, or wireless interfaces.

User interface system 1008 may include interfacing elements to receive user or operator programmed settings for operation of a power control system, such as for changing parameters 1010. User interface system 1008 can also provide feedback to users or operators on present settings held within parameters 1010. In some examples, user interface system 1008 receives and transfers various information over communication interface system 1007. User interface system 1008 may include separate user interface elements which include a software interface such as a terminal interface, command line interface, or application programming interface (API). User interface system 1008 may also include physical user interfaces, such as keyboard, a mouse, a voice input device, or a touchscreen input device for receiving input from a user. User interface system 1008 may include visualization/status interfaces, user command controls, and telemetry, such as user controls, start/stop controls, telemetry, operating mode control interfaces, visualization interfaces, and system characteristic calibration controls, among others. Output devices such as displays, speakers, web interfaces, terminal interfaces, and other types of output devices may also be included in user interface system 1008. User interface system 1108 may also include associated user interface software executable by processing system 1002 in support of the various user input and output devices discussed above.

The techniques described in this disclosure may also be embodied or encoded in an article of manufacture including a non-transitory computer-readable storage medium. Example non-transitory computer-readable storage media may include random access memory (RAM), read-only memory (ROM), programmable ROM, erasable programmable ROM, electronically erasable programmable ROM, flash memory, a solid-state drive, a hard disk, magnetic media, optical media, or any other computer readable storage devices or tangible computer readable media. The term “non-transitory” may indicate that the storage medium is not embodied in a carrier wave or a propagated signal. In certain examples, a non-transitory storage medium may store data that can, over time, change (e.g., in RAM or cache).

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The various circuit elements and interconnection architectures discussed herein are employed according to the descriptions above. However, it should be understood that the disclosures and enhancements herein are not limited to these circuit elements and interconnection architectures. Thus, the descriptions and figures included herein depict specific implementations to teach those skilled in the art how to make and use the best options. For the purpose of teaching inventive principles, some conventional aspects have been simplified or omitted. Those skilled in the art will appreciate variations from these implementations that fall within the scope of this disclosure. Those skilled in the art will also appreciate that the features described above can be combined in various ways to form multiple implementations.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, such as by an end user and/or a third party.

While the use of particular transistors is described herein, other transistors (or equivalent devices) may be used instead. For example, a p-channel field effect transistor (PFET) may be used in place of an n-channel field effect transistor (NFET) with little or no changes to the circuit. Furthermore, other types of transistors may be used (such as bipolar junction transistors (BJTs)). Furthermore, the devices may be implemented in/over a silicon substrate (Si), a silicon carbide substrate (SiC), a gallium nitride substrate (GaN) or a gallium arsenide substrate (GaAs). Moreover, reference to transistor features such as gate, source, or drain is not intended to exclude any suitable transistor technologies. For instance, features such as source, drain, and gate are typically used to refer to a FET, while emitter, collector, and base are typically used to refer to a BJT. Such features may be used interchangeably herein. For instance, reference to the gate of a transistor may refer to either the gate of a FET or the base of a BJT, and vice-versa. In some examples, a control terminal may refer to either the gate of a FET or the base of a BJT. Any other suitable transistor technologies can be used. Any such transistors can be used as a switch, with the gate or base or other comparable feature acting as a switch select input that can be driven to connect the source and drain (or the emitter and collector, as the case may be).

References herein to a field effect transistor (FET) being “ON” (or a switch being closed) means that the conduction channel of the FET is present, and drain current may flow through the FET. References herein to a FET being “OFF” (or a switch being open) means that the conduction channel is not present, and drain current does not flow through the FET. A FET that is OFF, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described examples, and other examples are possible within the scope of the claims.

What is claimed is:

1. A power controller, comprising:
a transient detection circuit configured to monitor a change in timing among pulse signals associated with voltage conversion phases supplying current to a load circuit; and
the transient detection circuit configured to identify a transient event condition corresponding to a change in current demand of the load circuit and responsively output an indication of the transient event condition.

2. The power controller of claim 1, wherein:
the transient detection circuit is configured to monitor separation between consecutive ones of the pulse signals;
based on the separation exceeding an overshoot entry threshold, the transient detection circuit is configured to identify and report an overshoot condition entry for the voltage applied to the load circuit; and
based on the separation falling below an undershoot entry threshold, the transient detection circuit is configured to identify and report an undershoot entry condition for the voltage applied to the load circuit.

3. The power controller of claim 2, wherein:
based on the separation falling below an overshoot exit threshold, the transient detection circuit is configured to identify and report an overshoot exit condition for the voltage applied to the load circuit; and
based on the separation increasing above an undershoot exit threshold, the transient detection circuit is configured to identify and report an undershoot exit condition for the voltage applied to the load circuit.

4. The power controller of claim 2, wherein:
the transient detection circuit is configured to monitor for changes in intervals between the pulse signals;
based on an increasing trend in the intervals, the transient detection circuit is configured to identify and report an overshoot exit condition for the voltage applied to the load circuit; and
based on a decreasing trend in the intervals, the transient detection circuit is configured to identify and report an undershoot exit condition for the voltage applied to the load circuit.

5. The power controller of claim 1, wherein:
based at least on the indication of the transient event condition indicating an overshoot event, a transient reduction circuit is configured to reduce the voltage applied to the load circuit by at least one of limiting the pulse signals that activate the voltage conversion phases and turning off transistors among the voltage conversion phases to reduce excess current supplied to the load circuit.

6. The power controller of claim 1, wherein:
based at least on the indication of the transient event condition indicating an undershoot event, a transient reduction circuit is configured to increase the voltage applied to the load circuit by at least one of turning on idle phases among the voltage conversion phases and shortening a minimum allowed time between the pulse signals that activate the voltage conversion phases.

7. The power controller of claim 1, comprising:
a set of programmable registers defining at least an entry threshold and an exit threshold for the transient event condition.

8. A method, comprising:
monitoring, in a power control circuit, a change in timing among pulse signals that activate voltage conversion phases supplying current to a load circuit;
based on a property of the change, determining, in the power control circuit, a transient event condition corresponding to a change in current demand of the load circuit; and
outputting, by the power control circuit, an indication of the transient event condition.

9. The method of claim 8, comprising:
monitoring, by the power control circuit, separation between consecutive ones of the pulse signals;
based on the separation exceeding an overshoot entry threshold, determining, by the power control circuit, an overshoot entry condition for the voltage applied to the load circuit; and
outputting, by the power control circuit, an indication of the overshoot entry condition.

10. The method of claim 9, comprising:
based on the separation falling below an overshoot exit threshold, determining, by the power control circuit, an overshoot exit condition; and
outputting, by the power control circuit, an indication of the overshoot exit condition.

11. The method of claim 9, comprising:
monitoring, by the power control circuit, for a decreasing trend in intervals between the pulse signals;
based on the decreasing trend, providing, by the power control circuit, an indication of an overshoot exit condition.

12. The method of claim 8, comprising:
monitoring, by the power control circuit, separation between consecutive ones of the pulse signals;
based on the separation falling below an undershoot entry threshold, determining, by the power control circuit, an undershoot entry condition for the voltage applied to the load circuit; and
outputting, by the power control circuit, an indication of the undershoot entry condition.

13. The method of claim 12, comprising:
based on the separation increasing above an undershoot exit threshold, determining, by the power control circuit, an undershoot exit condition; and
outputting, by the power control circuit, an indication of the undershoot exit condition.

14. The method of claim 12, comprising:
monitoring, by the power control circuit, for an increasing trend in intervals between the pulse signals;
based on the increasing trend, providing, by the power control circuit, an indication of an undershoot exit condition.

15. The method of claim 8, comprising:
providing, by the power control circuit, a set of programmable registers defining at least an entry threshold and an exit threshold for the transient event condition.

16. The method of claim 8, comprising:
based at least on the indication of the transient event condition indicating an overshoot event, in a transient reduction circuit, reducing, by the power control circuit, the voltage applied to the load circuit by at least one of limiting the pulse signals that activate the voltage conversion phases and turning off transistors among the voltage conversion phases to reduce excess current supplied to the load circuit.

17. The method of claim 8, comprising:
based at least on the indication of the transient event indicating an undershoot event, in a transient reduction circuit, increasing, by the power control circuit, the voltage applied to the load circuit by at least one of turning on idle phases among the voltage conversion phases and shortening the minimum allowed time between the pulse signals that activate the voltage conversion phases.

18. An apparatus, comprising:
one or more computer readable storage media;
program instructions stored on the one or more computer readable storage media, the program instructions executable by a processing system to direct the processing system to at least:
monitor spacing among pulse signals that activate voltage conversion phases supplying current to a load circuit;
based on a property of the spacing, determine a transient event condition corresponding to a change in current demand of the load circuit; and
output an indication of the transient event condition.

19. The apparatus of claim 18, comprising further instructions executable by the processing system to direct the processing system to at least:
based on the spacing exceeding an overshoot entry threshold, indicate an overshoot entry condition for the voltage applied to the load circuit;
based on the spacing falling below an overshoot exit threshold or based on a decreasing trend in intervals between the pulse signals, indicate an overshoot exit condition for the voltage applied to the load circuit;
based on the spacing falling below an undershoot entry threshold, indicate an undershoot entry condition for the voltage applied to the load circuit; and
based on the spacing increasing above an undershoot exit threshold or based on an increasing trend in the intervals, indicate an undershoot exit condition for the voltage applied to the load circuit.

20. The apparatus of claim 18, comprising further instructions executable by the processing system to direct the processing system to at least:
based at least on the indication of the transient event condition indicating an overshoot event, instruct a transient reduction circuit to reduce the voltage applied to the load circuit by at least one of limiting the pulse signals that the activate voltage conversion phases and turning off transistors among the voltage conversion phases to reduce excess current supplied to the load circuit; and
based at least on the indication of the transient event condition indicating an undershoot event, instruct the transient reduction circuit to increase the voltage applied to the load circuit by at least one of turning on idle phases among the voltage conversion phases and shortening the minimum allowed time between the pulse signals that activate the voltage conversion phases.
